(19) United States
(12) Patent Application Publication
(10) Pub. No.: US 2025/0162117 A1
(43) Pub. Date: May 22, 2025

(54) LIFTER WITH SHIELD FOR FASTENER DRIVING TOOLS

(71) Applicant: Kyocera Senco Industrial Tools, Inc., Cincinnati, OH (US)

(72) Inventor: Thomas A. McCardle, Fairfield, OH (US)

(73) Assignee: Kyocera Senco Industrial Tools, Inc., Cincinnati, OH (US)

(21) Appl. No.: 18/952,081

(22) Filed: Nov. 19, 2024

Related U.S. Application Data
(60) Provisional application No. 63/601,412, filed on Nov. 21, 2023.

(51) Int. Cl. B25C 1/04

(52) U.S. Cl. CPC B25C 1/047

(57) ABSTRACT

A shield subassembly for fastener driving tools is provided that is operable to prevent an interference condition. The shield subassembly includes a rotary-to-linear lifter with lifter pins and a driver with protrusions, and the lifter pins are individually biased so as to be individually retractable and extendable. The lifter is operable to perform a lift stroke in order to raise the driver to a ready position, and then begin a drive stroke to force a fastener into a substrate. The shield subassembly includes a ramp that forces each lifter pin to partially retract so as not cause an interference condition upon contact with a driver protrusion. Once the lifter pin is rotated past the shield and contact ceases, that lifter pin extends and can then slide under a misaligned driver protrusion, or make contact and begin the lift stroke.

### CROSS-REFERENCE TO RELATED APPLICATIONS

The present application claims priority to provisional patent application Ser. No. 63/601,412, titled “LIFTER WITH SHIELD FOR FASTENER DRIVING TOOLS,” filed on Nov. 21, 2023.

### TECHNICAL FIELD

The technology disclosed herein relates generally to fastener driving tools and is particularly directed to tools that utilize a gas spring and a lifter. Embodiments are specifically disclosed as a shield subassembly for a fastener driving tool, including a lifter subassembly having a plurality of individually-biased lifter pins, a driver with a plurality of protrusions, and a shield. The shield exhibits a ramp that forces each lifter pin to partially retract when each pin contacts the ramp, as the lifter subassembly rotates. Once contact with the ramp ceases, each lifter pin is allowed to extend and is operable to contact one of the driver protrusions. However, if the physical position of the driver is misaligned, the first lifter pin will slide under the first driver protrusion, which is possible due to the ramp initially forcing each lifter pin to partially retract, until that first lifter pin moves past the misaligned (first) driver protrusion. Once the first lifter pin clears the first (misaligned) driver protrusion, that first lifter pin is allowed to fully extend, and is operable to contact an edge of the next (a second) driver protrusion, which then begins the lifting stroke.

The fastener driving tool includes a self-contained pressurized gas stored in a sealed pressure chamber, and a removable battery pack. Actuating a trigger on the tool rotates a motor-driven rotary-to-linear lifter that initially holds a piston and the driver at a “ready position.” After the lifter begins to rotate, the pressurized gas then forces the piston and the driver towards an exit end of the tool with sufficient force to drive a fastener (such as a pin or nail) into a substrate; this actuation procedure is sometimes referred to herein as a “drive stroke” or a “driving stroke.”

After the drive stroke, the lifter subassembly is actuated automatically and continues to rotate. The lifter subassembly includes a plurality of lifter pins positioned around at least one lifter disk. The driver includes a plurality of lifter “teeth,” or protrusions, that the lifter pins “catch” during a “return stroke,” which can also be referred to as a “lifting stroke,” if desired. During a return stroke, the lifter disk rotates, which forces an extended lifter pin to “catch” and start “lifting” a first driver protrusion, assuming the driver is not mispositioned. The lifter disk continues to rotate, and consecutive lifter pins catch and lift consecutive driver protrusions. The return stroke ends when the piston and driver are positioned back in the ready position. Under user control, another drive stroke begins again, using the same compressed gas. As noted above, the pressurized gas is generally reusable for multiple thousands of drive strokes.

The fastener driving tool is generally a portable cordless tool that drives staples, nails, pins, or other linearly driven fasteners. The tool is also specifically disclosed as a gas spring linear fastener driving tool, in which the working cylinder containing pressurized gas is used to quickly force its piston through a driving stroke movement, while also driving a fastener into a workpiece. The piston is then moved back to its starting position by use of the rotary-to-linear lifter, which further compresses the gas above the piston, thereby preparing the tool for another driving stroke. The driver is typically attached to the piston (at least during the drive stroke), and has protrusions along at least one of its surfaces that are used to contact the lifter, which lifts the driver (and piston) during a return stroke.

### STATEMENT REGARDING FEDERALLY SPONSORED RESEARCH OR DEVELOPMENT

None.

### BACKGROUND

Fastener driving tools for driving nails, staples, or pins are common. Typically, gas spring tools use an electrically-powered lifter to reset the driver and piston for each consecutive drive stroke. The lifters typically have extensions, such as lifter pins, which contact driver protrusions, or driver “teeth,” in order to “lift” the driver and piston back to a ready position.

A common problem with these types of tools is that sometimes the driver is misaligned after a drive stroke, causing the lifter pins to clash with the driver protrusions (i.e., the pins contact the protrusions in a manner that prevents a lift stroke from occurring). This misalignment between the pins and the protrusions can cause a jam condition in which the lift stroke cannot occur.

### SUMMARY

Accordingly, it is an advantage to provide a shield subassembly for a fastener driving tool, in which the tool contains a driver with a plurality of protrusions and a lifter that includes a plurality of lifter pins and a shield, in which the shield is operable to prevent a misaligned contact between the plurality of lifter pins and the plurality of protrusions.

It is another advantage to provide a shield subassembly for a fastener driving tool, in which the tool includes a lifter subassembly having a plurality of lifter pins, a driver exhibiting a plurality of protrusions, a guide body, and a shield that is integrated into the guide body, such that the shield is operable to prevent a misaligned contact between the plurality of lifter pins and the plurality of protrusions.

It is yet another advantage to provide a shield subassembly for a fastener driving tool, in which the tool includes a lifter subassembly having a plurality of lifter pins, a driver exhibiting a plurality of protrusions, a guide body, and a shield that is mounted between the lifter subassembly and the guide body, such that the shield is operable to prevent a misaligned contact between the plurality of lifter pins and the plurality of protrusions.

It is still another advantage to provide a shield subassembly for a fastener driving tool, in which the tool includes a lifter having a plurality of individually-biased lifter pins that are individually extendable and retractable, and a shield that exhibits a ramp portion, in which the ramp is operable to force each lifter pin to slightly retract upon contact, and then release each lifter pin when contact ceases, thereby allowing each lifter pin to extend.

It is a further advantage to provide a shield subassembly for a fastener driving tool, in which the tool contains a driver with a plurality of protrusions and a lifter that includes a plurality of lifter pins and a shield, and if the driver is misaligned after a drive stroke, then the shield prevents a lifter pin from contacting the edge of the misaligned driver, except at a permissible position that will not cause a jam.

It is a yet further advantage to provide a shield subassembly for a fastener driving tool, in which the tool contains a driver with a plurality of protrusions and a lifter that includes a plurality of lifter pins and a shield, and if the driver is misaligned after a drive stroke, then the shield is sized and shaped to force the lifter pins to partially retract so that when the lifter pins clear the shield, the lifter pins will only partially extend so as to slide along a surface of a first driver protrusion, and after clearing the first driver protrusion, then the lifter pins can fully extend to contact the edge of a second driver protrusion, and then cause the driver to undergo a return stroke.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, a lifter for use in a fastener driving machine is provided, in which the lifter comprises: a rotatable lifter shaft including a first end and a second end, and a longitudinal axis that extends at least between the first end and the second end; an actuator that is positioned between the first and second ends; a rotatable lifter subassembly, including: a holder that is positioned proximal to the actuator, and is movable by action of the actuator, the holder exhibiting a second plurality of openings; a guide that is positioned proximal to the holder, the guide exhibiting a first plurality of openings; a return spring that provides a force against the holder in a direction that is substantially parallel to the longitudinal axis of the lifter shaft; and a plurality of lifter pins that are seated in the second plurality of openings and that are movable in a direction substantially parallel to the longitudinal axis; and a shield that is positioned proximal to the second end and that covers at least a portion of the plurality of lifter pins, the shield is operable to force at least one of the plurality of lifter pins to partially retract in a direction towards the actuator during a lifting stroke.

In accordance with another aspect, a portable fastener driving tool is provided, which comprises: a pressure chamber containing a pressurized gas; a working cylinder that includes a movable piston, in which the working cylinder exhibits a first end and a second, opposite end; a movable driver that is in communication with the movable piston at least during a drive stroke; a rotatable lifter subassembly that is in communication with the movable driver at least during a return stroke; a motor that provides power to the lifter subassembly; and a shield that is in mechanical communication with the lifter subassembly at least during the return stroke, in which the shield is operable to prevent an interference condition between the movable driver and the rotatable lifter subassembly.

In accordance with yet another aspect, a lifter for use in a fastener driving machine is provided, in which the lifter comprises: a rotatable lifter shaft including a first end and a second end; an actuator that is positioned between the first and second ends; a rotatable lifter subassembly, including: a holder that is positioned proximal to the actuator; at least one guide that is positioned proximal to the holder, the at least one guide exhibiting a first plurality of openings; a return spring proximal to the holder; and a plurality of lifter pins that at least partially extend through the first plurality of openings; and a shield that covers at least a portion of the plurality of lifter pins.

In accordance with still another aspect, a method for lifting a driver in a fastener driving tool is provided, in which the method comprises: (a) providing: a pressure chamber containing a pressurized gas; a working cylinder that includes a movable piston, said working cylinder being in fluidic communication with the pressure chamber, in which the working cylinder exhibits a first end and a second, opposite end; a movable driver that is in communication with the movable piston at least during a drive stroke, the movable driver moving through a driver track between at least a “ready” position and a “driven” position; a lifter subassembly that is in communication with the movable driver at least during a return stroke; a prime mover that provides power to the lifter subassembly; and a shield that is in mechanical communication with the lifter subassembly at least during the return stroke; (b) rotating the lifter subassembly during an initial phase of the return stroke, and using the shield to force the at least one lifter pin to at least partially retract which, if the movable driver is misaligned, prevents the at least one lifter pin from physically contacting an edge of a first protrusion of the movable driver; and (c) after the initial phase of the return stroke, fully extending the at least one lifter pin of the lifter subassembly so as to make physical contact with an edge of a second protrusion of the movable driver, and further rotating the lifter subassembly so as to lift the movable driver toward a “ready” position.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a front view of a shield subassembly for a fastener driving tool, as constructed according to the principles of the technology disclosed herein.

FIG. 2 is a side view of a lifter subassembly of the shield subassembly of FIG. 1.

FIG. 3 is a cutaway view along the line 3-3 of the lifter subassembly of FIG. 2

FIG. 4 is a rear perspective view of the shield subassembly of FIG. 1, showing a ramp and a driver track.

FIG. 5 is a top view of the shield subassembly of FIG. 1, showing the ramp and driver track.

FIG. 6 is a front view of the shield subassembly of FIG. 1, showing a random “first pin” position in dashed lines.

FIG. 7 is a front view of the shield subassembly of FIG. 1, showing an optimal lift position between the “first pin” and the driver protrusions in dashed lines.

FIG. 8 is a front view of the shield subassembly of FIG. 1, showing another optimal lift position between the “first pin” and the driver protrusions in dashed lines.

FIG. 9 is a front view of the shield subassembly of FIG. 1, showing a misaligned driver that would necessitate the use of the shield to prevent a misaligned contact with the “first pin” in dashed lines.

FIG. 10 is a front view of the shield subassembly of FIG. 1, showing a maximum distance between the “first pin” and the driver protrusion that would not require the shield to prevent a misaligned contact in dashed lines.

FIG. 11 is a front view of the shield subassembly of FIG. 1, showing the position of the rotary lifter as a lifter pin first clears the shield.

FIG. 12 is a front view of the shield subassembly of FIG. 1, showing the beginning of a drive stroke in dashed lines.

FIG. 13 is a front view of the shield subassembly of FIG. 1, showing an optimal ready position of the driver-lifter combination in dashed lines.

FIG. 14 is an exploded view of a first alternative embodiment shield subassembly, showing the lifter and the shield, as constructed according to the principles of the technology disclosed herein.

FIG. 15 is a side view of the shield subassembly of FIG. 14.

FIG. 16 is a front view of the shield subassembly of FIG. 14, showing a driver exhibiting a plurality of protrusions at the end of a drive stroke.

FIG. 17 is a perspective view of the lifter of FIG. 16, showing all of the lifter pins in an extended position and ready for a lift stroke.

FIG. 18 is a front view of the shield subassembly of FIG. 14, showing an interference position between a “first pin” and one of the plurality of protrusions.

FIG. 19 is an enlarged view along the line 19-19 of FIG. 18, showing the shield forcing the “first pin” to partially retract and able to slide under the misaligned driver protrusion.

FIG. 20 is a front view of the shield subassembly of FIG. 14, showing a blocked position.

FIG. 21 is a perspective view of the lifter of FIG. 20, showing the two blocked pins partially retracted, and the remaining unblocked pins fully extended.

FIG. 22 is a front view of the shield subassembly of FIG. 14, showing a retracted position at the end of a drive stroke before the pins extend to begin a lift stroke.

FIG. 23 is a perspective view of the lifter of FIG. 22, showing all of the pins fully retracted.

FIG. 24 is a front view of the shield subassembly of FIG. 14, showing a ready position in which one pin is extended and holding a single driver protrusion.

FIG. 25 is a perspective view of the lifter of FIG. 24, showing one pin fully extended and the other pins fully retracted.

FIG. 26 is a front view of the shield subassembly of FIG. 14, showing a near interference position in which the “first pin” is still partially retracted due to the shield and is able to slide under the driver protrusion.

FIG. 27 is an enlarged view along the line 27-27 of FIG. 26, showing the “first pin” in contact with both the shield and the driver protrusion.

FIG. 28 is a rear view of a second alternative embodiment shield, in which the shield exhibits an extended ramp, as constructed according to the principles of the technology disclosed herein.

FIG. 29 is a rear view of a third alternative embodiment shield, in which the shield exhibits a truncated ramp, as constructed according to the principles of the technology disclosed herein.

FIG. 30 is a left-side view of a fastener driving tool.

FIG. 31 is an exploded view of the fastener driving tool of FIG. 30.

FIG. 32 is an exploded view of the lifter subassembly of FIG. 2, showing a plurality of lifter pin springs that individually bias each lifter pin.

FIG. 33 is a partial cutaway view of the shield and lifter subassemblies of FIG. 1, showing a lifter extension directly in contact with the ramp and about to slide behind a driver protrusion.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

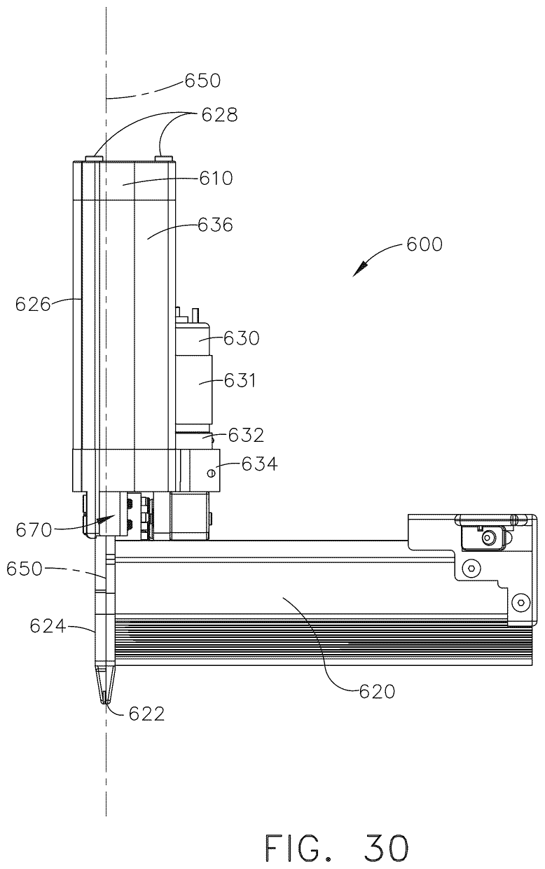

Referring now to FIG. 1, a shield subassembly (“S/A”) for use in a fastener driving tool is generally designated by the reference numeral 10. The shield S/A 10 includes a driver 22 which exhibits a first longitudinal axis 15, a lifter subassembly (“S/A”) 30 that has a plurality of lifter pins 32 (or “lifter extensions” 32), and a shield 20 (which is part of a “guide body” in this first embodiment) that exhibits a first side 68, a second side 69 (see FIG. 4), and a fastener exit end 24. The shield 20 and the lifter S/A 30 are typically positioned near the front of a fastener driving tool 600 (see FIG. 30). When the tool 600 is actuated, the driver 22 travels from the top (in this view) towards the fastener exit end 24 and drives a fastener (such as a nail, staple, brad, or pin, for example) into a workpiece. This driving event is sometimes referred to herein as a “drive stroke,” or a “driving stroke.”

After the drive stroke has completed, the driver 22 needs to be returned to a “ready position” in order to drive another fastener. The lifter S/A 30 is actuated and begins to rotate. The plurality of lifter pins 32 contact a plurality of driver protrusions (or “teeth”) 26 (see FIG. 3), and “lift” the driver 22 back to the ready position. This lifting event is sometimes referred to herein as a “lift stroke,” or a “return stroke.”

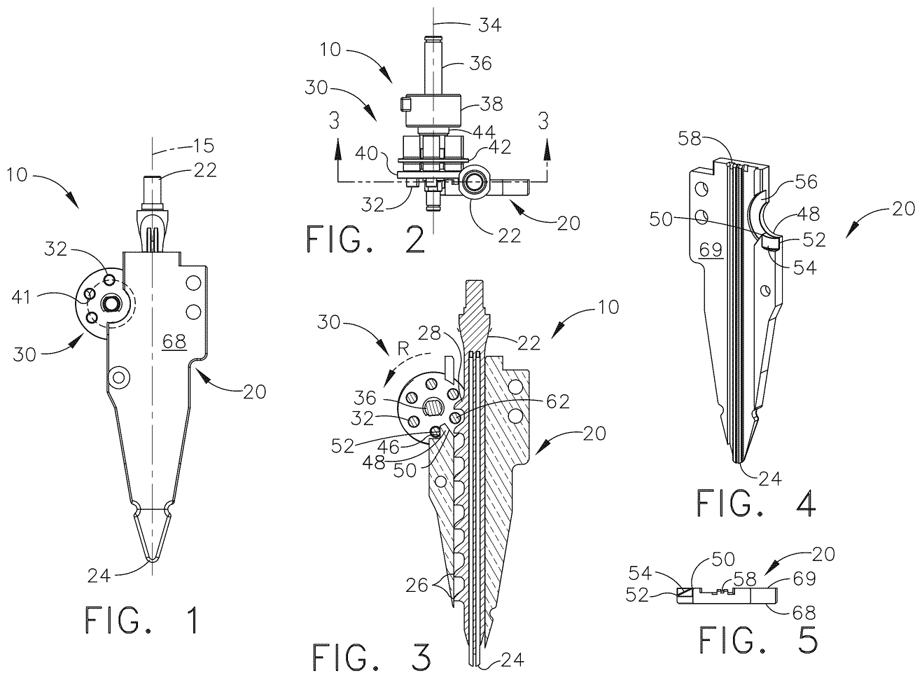

Referring now to FIG. 2, some of the components of the lifter S/A 30 are depicted, including: a lifter shaft 36, having a first end and a second end, which exhibits a second longitudinal axis 34, a solenoid 38, a plunger 44 (part of the solenoid), a holder 42, and a guide 40. The guide 40 exhibits a first plurality of openings 41 (see FIG. 1) in which the plurality of lifter pins 32 can linearly slide parallel to the second longitudinal axis 34. The first longitudinal axis 15 is substantially perpendicular to the second longitudinal axis 34. The solenoid 38 and the plunger 44 are sometimes referred to herein as an “actuator.” The second longitudinal axis 34 extends at least between the first end and the second end of the lifter shaft 36

Referring now to FIG. 3, a cutaway view along the section line 3-3 of FIG. 2 is depicted. The driver 22 has a first protrusion 28 that is typically contacted first during a lift stroke by a first lifter pin 46, and this is considered an “in specification” position. The shield exhibits a portion 48 of the first shield side 68 that has an entrance edge 52 and an exit edge 50. A rotation R indicates the preferred rotational direction of the lifter S/A 30. However, in this view the driver 22 has stopped in a position such that the first driver protrusion 28 will instead be contacted by a second lifter pin 62. It should be noted that this is also considered an “in specification” position, because a proper lift stroke will occur. In the “in specification” position, one of the lifter pins (such as the second lifter pin 62, in FIG. 3) contacts an edge of one of the driver protrusions (such as the first driver protrusion 28, in FIG. 3) and forces the driver 22 “upwards” (in this view) towards the ready position. The continuous contact of each lifter pin to an edge of each driver protrusion, until the driver 22 has been moved to the ready position, is considered a “normal lift.”

In other words, as each driver protrusion is contacted by one of the lifter pins, that ‘present’ driver protrusion essentially stays in contact with that particular (‘present’) lifter pin during a ‘present’ portion of the rotation of the lifter subassembly, and the ‘next’ lifter pin will contact the ‘next’ driver protrusion just before the ‘present’ lifter pin falls away from the ‘present’ driver protrusion (as the lifter subassembly continues to rotate), and thereby releases from contacting that ‘present’ driver protrusion. In this manner, there essentially is a continuous contact between the plurality of lifter pins and the plurality of driver protrusions, even though the individual lifter pins and driver protrusions exhibit a discontinuous type of contacting surface.

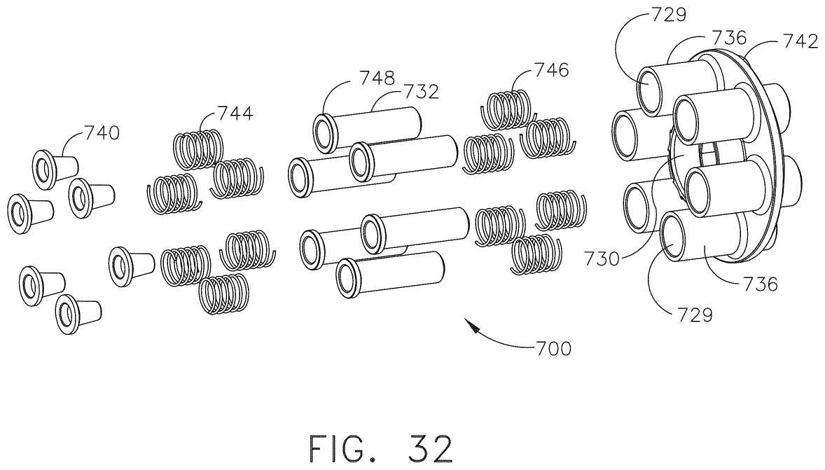

Referring now to FIG. 4, the second side 69 of the shield 20 is depicted. Between the entrance edge 52 and the exit edge 50 is a ramp 54, and beyond the exit edge 50 is a guide 56. (The portion 48 of the first shield side 68 is exactly opposite the ramp 54 of the second shield side 69, in the view of FIG. 3.) When the lifter S/A 30 begins to rotate, the first lifter pin 46 moves to the entrance edge 52. As the first lifter pin 46 contacts the ramp 54, it is forced to partially retract in a direction parallel to the second longitudinal axis 34. Once the first lifter pin 46 slides to the exit edge 50 and then continues sliding, the first lifter pin 46 is allowed to extend and can contact the guide 56, assuming the driver 32 is not misaligned. Each lifter pin undergoes the same retracting and extending movement as each lifter pin contacts and slides along the ramp 54. The plurality of lifter extensions 32 are individually biased to allow this retracting and extending movement (see FIG. 32). The shield 20 exhibits a driver track 58 along which the driver 22 contacts and slides along during a drive stroke and a lift stroke. The driver 22 is mechanically bound to linear travel by the driver track 58.

Referring now to FIG. 5, the incline of the ramp 54 is depicted, which forces the compression (or retraction) during contact by each lifter pin 32 during a lift stroke. The angle of incline of the ramp 54 is variable, and depends on the distance between the front side of the guide 40 and the “back” of the driver 22. Essentially, the exit edge 50 is positioned such that when each lifter pin 32 contacts and is compressed by the ramp 54, each lifter pin 32 will slip “under” a misaligned driver protrusion.

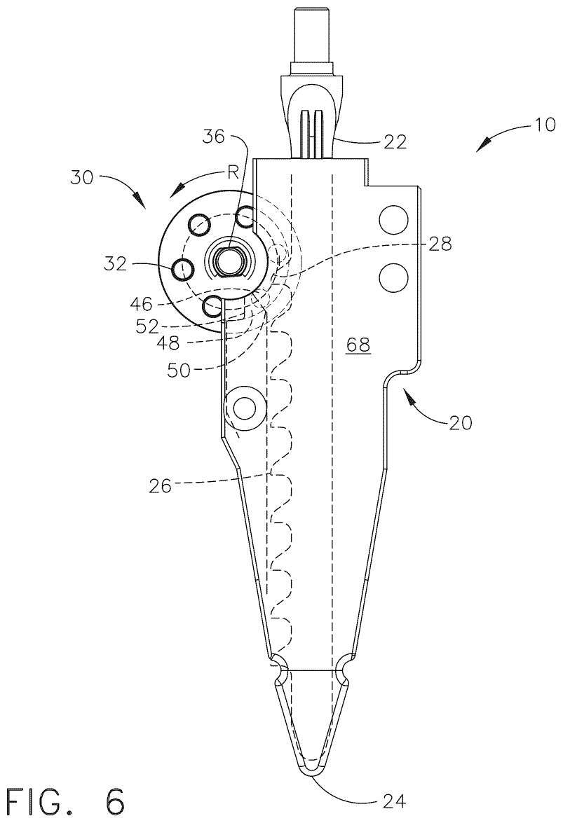

Referring now to FIG. 6, the driver 22 is depicted in a random position after the end of a drive stroke, and the first lifter pin 46 is partially compressed due to its contact with the ramp 54. Note that in FIG. 6, the first driver protrusion's 28 position is somewhat lower (in this view) than the lifter shaft 36. In FIGS. 6-10, the first lifter pin 46 is depicted as having its centerline on the edge of the exit edge 50.

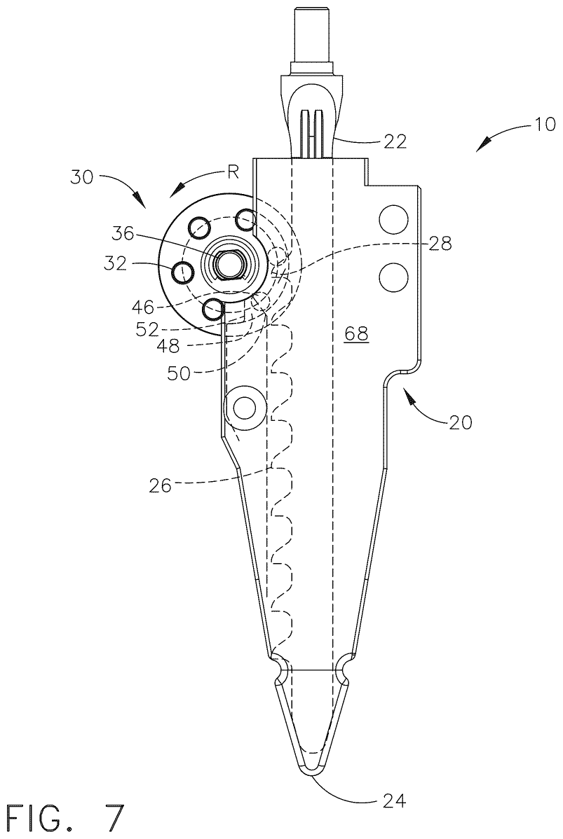

Referring now to FIG. 7, an optimal lift situation is depicted. The first lifter pin 46 is partially extended and in contact with the ramp 54. Once the lifter S/A 30 begins rotating, the first lifter pin 46 will slide past the exit edge 50 and fully extend and continue rotating until the first lifter pin 46 contacts an edge of the first driver protrusion 28, thereby beginning to ‘lift’ the driver 22 back to the ready position.

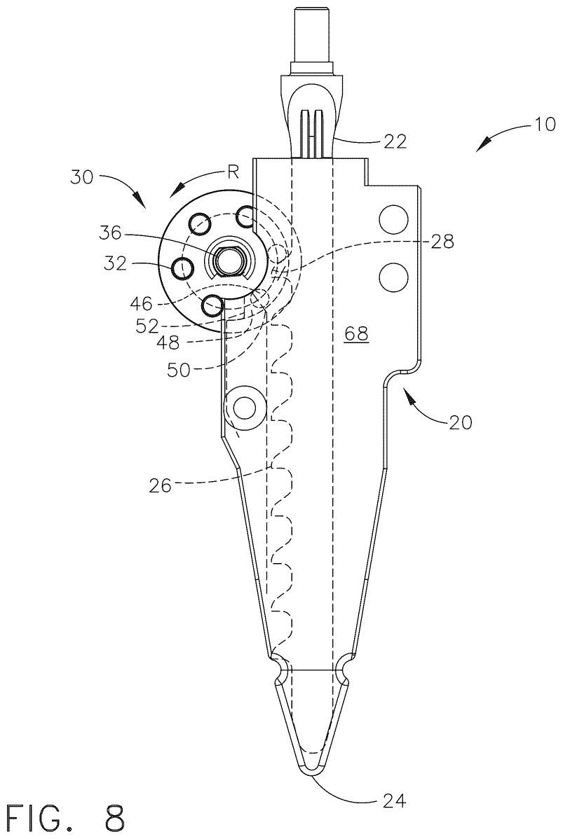

Referring now to FIG. 8, another optimal lift situation is depicted. The driver 22 is depicted at a lower position than in FIGS. 6 and 7. However, once the lifter S/A 30 begins rotating, the first lifter pin 46 will slide clear of the exit edge 50, fully extend, and then contact an edge of the first driver extension 28, thereby beginning the lift stroke.

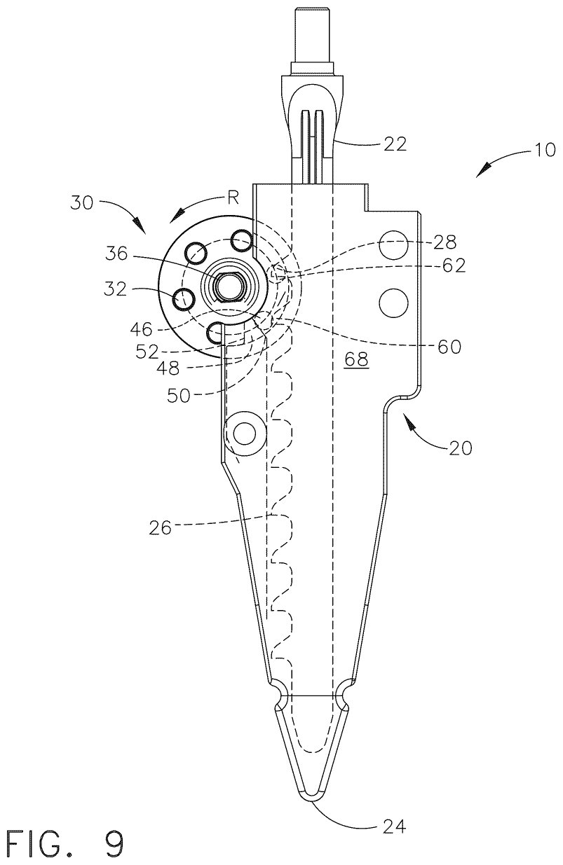

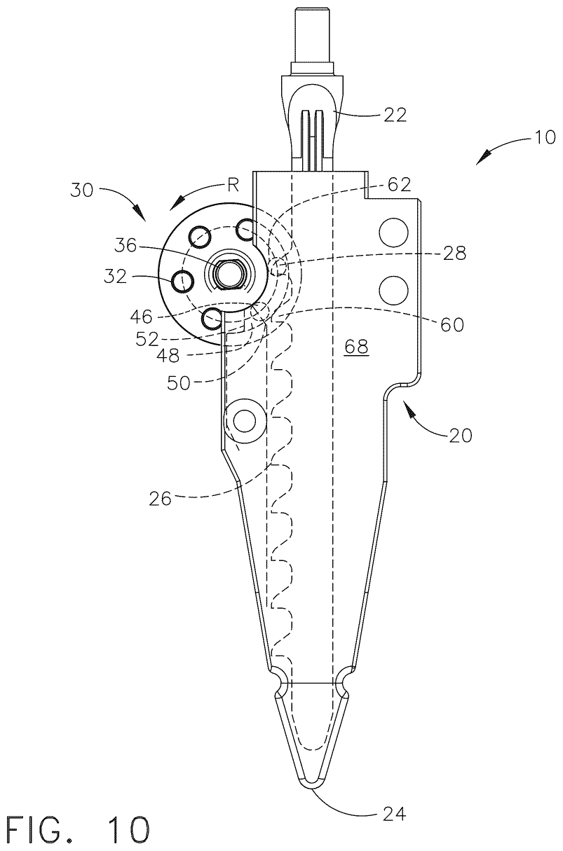

Referring now to FIG. 9, the driver 22 is depicted in a higher position than in FIG. 8; however, in FIG. 9 the shield 20 is necessary to prevent an interference condition. In FIG. 9, the first driver protrusion 28 has stopped significantly higher than in the previous drawings (possibly due to a jam, or bent fastener, for example). The ramp 54 is partially compressing the first lifter pin 46 to avoid an interference condition with a second driver protrusion 60, and the second lifter pin 62 is partially extended and contacting the rear portion of the first driver protrusion 28 to begin the lift stroke. Once the lifter S/A 30 begins rotating, the second lifter pin 62 will slide out of contact with the first driver protrusion 28 and full extend, and the first lifter pin 46 will slide behind the second driver protrusion 60 and then fully extend and able to contact an edge of the first driver protrusion 28.

Without the shield 20, the first lifter pin 46 would contact the second driver protrusion 60 near the tip of the second driver protrusion, and then be unable to lift the driver 22. What would happen in this situation is that the lifter S/A 30 rotation would be forcing the first lifter pin 46 to push the second driver protrusion 60 and the driver 22 laterally (i.e., horizontally in this view). In other words, this would be an interference condition. However, the shield 20 resolves this issue by using the ramp 54 to compress the first lifter pin 46, which would allow that pin to slide under the second driver protrusion 60 and avoid the interference condition.

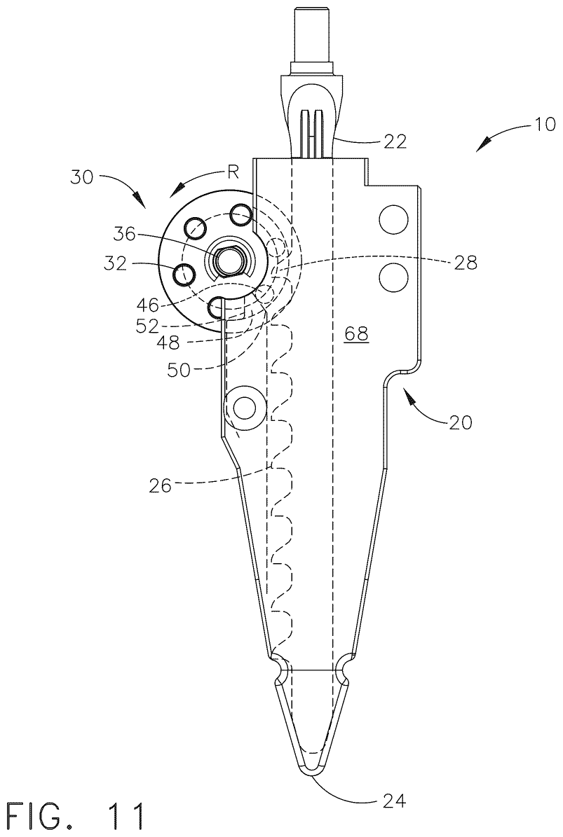

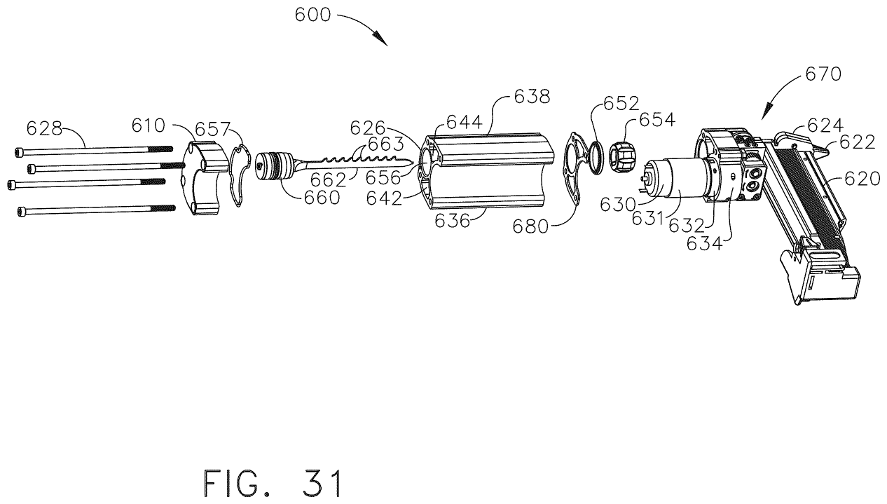

Referring now to FIG. 10, the driver 22 is depicted in a “maximum offset” position in which the first lifter pin 46 would contact and lift the first driver protrusion 28 without the shield. Note that the first driver protrusion's 28 position in FIG. 10 is somewhat higher (in this view) than in FIG. 6. The somewhat random position of the driver 22 after a drive stroke illustrated in FIGS. 6-11 may occur due to several factors, such as length of fastener being driven, hardness of the workpiece, and wear on a piston stop or bumper 654 (see FIG. 31). The longer the tool 600 is in use, the more wear on the bumper 654, and the lower the position of the driver 22 after a drive stroke. Of course, this takes many thousands of drive strokes to significantly wear the bumper 654 down to a point where the driver 22 may be completely out of position for a lift stroke.

This random driver 22 position is taken into consideration at the start of a lift stroke. For example, if the driver's 22 position is too far below from the lifter shaft's 36 centerline, then every lifter pin 32 will compress at contact with the ramp 54, and stay compressed as each pin slides under the first driver protrusion 28; i.e., a lift is impossible.

One possible solution is to only have the lifter S/A 30 rotate for a set amount of time, and if the tool 600 has not confirmed that the driver 22 has returned to the ready position, then to turn off the lifter S/A. Another possible solution is to put an extra driver protrusion before the first driver protrusion 28. Yet another possible solution is if the driver 22 is sticking out of the fastener exit end 24, then the user will just push the driver back into place. If any of these possible driver 22 positions occur during operation, it can be a sign that the bumper 654 has worn out and needs to be replaced.

It should be noted that if one of the driver protrusions 26 is misaligned (i.e., the driver 22 is misaligned), such that a lifter pin 32 cannot contact that driver protrusion properly to initiate a lift stroke, the ramp 54 forcing that lifter pin 32 to retract also allows the lifter pin to extend once the lifter pin has rotated past the ramp. However, the lifter pin 32 will only extend far enough to contact a rear surface of the misaligned driver protrusion 26, such that the lifter pin 32 will contact and slide along that rear surface until it has rotated past that misaligned driver protrusion 26, at which point that lifter pin will then fully extend.

Another consideration for the lift stroke is the speed of rotation of the lifter S/A 30. If the lifter S/A 30 is rotating too fast, the first lift pin 46 may not have enough time to decompress and extend after leaving contact with the exit edge 50, and will then miss contact with the first driver protrusion 28. One possible solution is to start the lifter S/A 30 rotation at a reduced speed (such as 50 RPM, for example), and then accelerate to a normal lifting speed (such as 360 RPM, for example).

Referring now to FIG. 11, the first lifter pin 46 is depicted having just cleared the exit edge 50 of the ramp 54. FIG. 10 illustrates a “maximum offset” in which the first lifter pin 46 will both clear the ramp 54 and still correctly contact the first driver protrusion 28 in order to start the lift stroke. In other words, at the end of a drive stroke, if the first driver protrusion's 28 position ends is too far down (in this view), then the ramp 54 will prevent any lifter pin 32 from correctly contacting the first driver protrusion. However, the ramp 54 will also then prevent an interference condition, in which the first lifter pin 46 would potentially clash with the first driver protrusion 28.

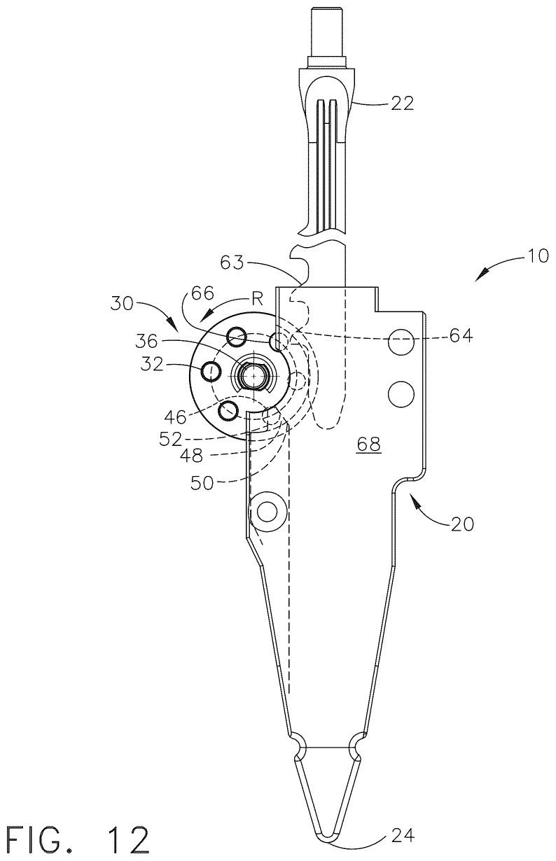

Referring now to FIG. 12, the beginning of a drive stroke is illustrated. The driver 22 has been previously lifted to the ready position and held in place by a single lifter pin 66 (a “last lifter pin”) by a last driver protrusion 64. In FIG. 12, all of the other lifter pins 32 have been retracted inside the lifter S/A 30 and out of contact range with the driver protrusions 26. When the drive stroke begins, the lifter S/A 30 rotates enough so that the last driver protrusion 64 “rolls off” of the last lifter pin 66 and then quickly travels towards the fastener exit end 24 due to the gas spring (see FIGS. 30-31). The last lifter pin 66 then quickly retracts to join the other lifter pins 32.

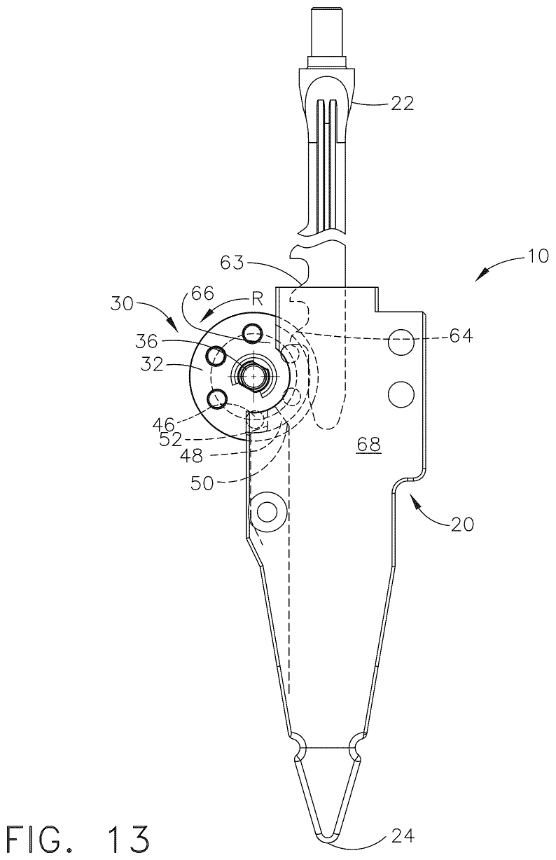

Referring now to FIG. 13, the ready position is illustrated. The last lifter pin 66 is shown holding the last driver protrusion 64. As noted above, all of the other lifter pins 32 are retracted inside the lifter S/A 30.

### Second Embodiment

Referring now to FIG. 14, a first alternative embodiment shield subassembly (S/A) is generally depicted by the reference numeral 210. The shield S/A 210 includes a shield 220, a clip 214, a lifter subassembly (S/A) 230, a spring 212, a plunger 244, a solenoid 238, and a lifter shaft 236. The lifter S/A 230 includes a guide 240, a holder 242, and a plurality of lifter pins 232 that are seated in the holder. The lifter shaft 236 exhibits a first longitudinal axis 234. The guide 240 exhibits a first plurality of openings 241 in which the plurality of lifter pins 232 can linearly slide parallel to the first longitudinal axis 234.

The shield 220 includes a fastener through-hole 216, a central through-hole 218, a first clip 270, a second clip 272, a first side 268, a second side 269, an entrance edge 252, a guide 256, a ramp 254, and an exit edge 250. The shield 220 is mounted to a chassis 634 of the tool 600 (see FIGS. 30-31) using a fastener secured in the fastener through-hole 216, and the shield 220 is positioned on the lifter shaft 236 using the central through-hole 218. The lifter S/A 230 is mounted proximal to the second side 269, and then the plunger 244 and the solenoid 238 are both mounted behind the lifter S/A (in this view), so that the lifter shaft 236 is the central mounting point for all of these structures.

During a lift stroke, the solenoid 238 is actuated which forces the plunger 244 towards the shield 220. This plunger 244 movement also forces the holder 242 to move towards the shield 220 and partially compresses the spring 212. The plurality of lifter pins 232 also move and fully extend through the guide 240. However, the shield 220 is stationary, so any pins in contact with the shield will either be constrained by the guide 256, or partially compressed due to the ramp 254. Each lifter pin 232 exhibits independent movement parallel to the first longitudinal axis 234 (see FIG. 32).

Once the lift stroke completes, the solenoid 238 is deactuated which allows the spring 212 to decompress and force the holder 242 and the plunger 244 away from the shield 220. The plurality of lifter pins 232 retract along with the holder 242, except for a single lifter pin 266 that is unable to retract due to the force of a last driver protrusion 264 of a driver 222 pressing on that pin (see FIG. 25). This is referred to as the ready position.

The drive stroke begins by the lifter S/A 230 rotating far enough so that the last driver protrusion 264 “rolls off” of the last lifter pin 266. Once the last lifter pin 266 is no longer contacting the last driver protrusion 264, the pin will retract and seat with the remaining lifter pins 232. The driver 222 will then quickly move towards the fastener exit end 622, due to the force of the gas spring, and drive a fastener into a workpiece. FIG. 12 shows an example of the drive stroke condition.

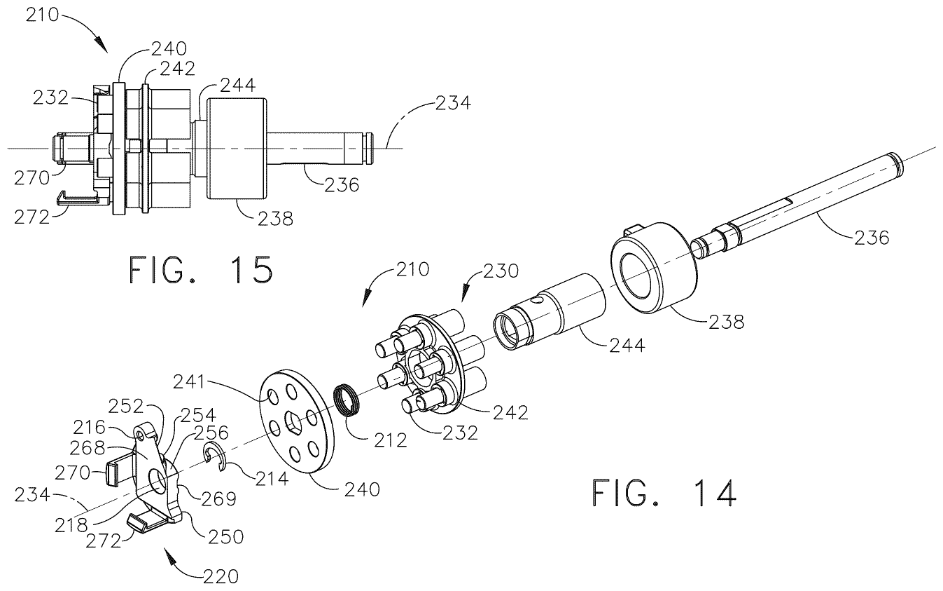

Referring now to FIG. 15, the shield S/A 210 is depicted showing the plurality of lifter pins 232 extended and ready to begin a lift stroke. The plunger 244 and the holder 242 are also extended in this view.

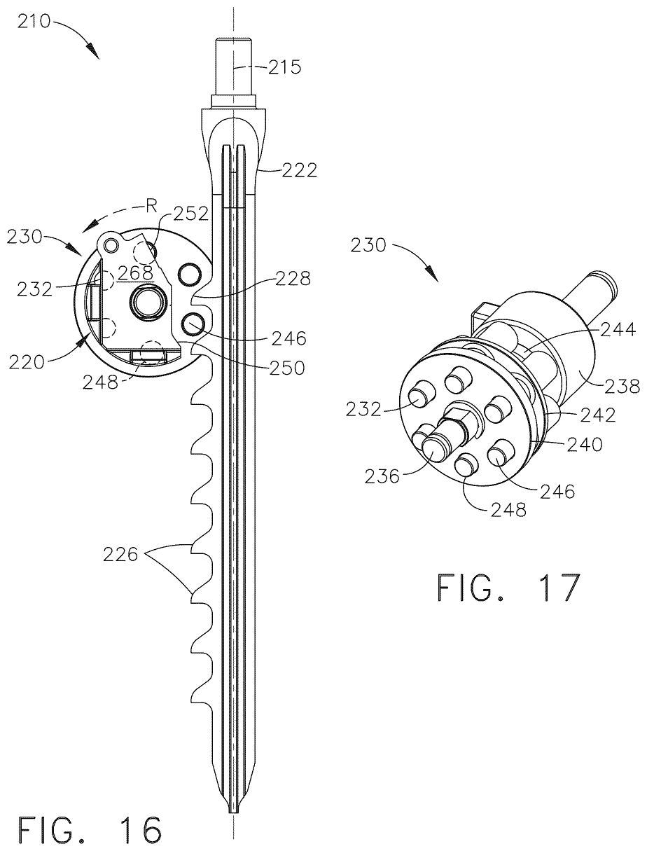

Referring now to FIG. 16, the shield S/A 210 is depicted showing the plurality of lifter pins 232 extended and ready to being a lift stroke. The driver 222 is also depicted, having a plurality of driver protrusions (or “teeth”) 226, and exhibiting a first longitudinal axis 215. It should be noted that the first longitudinal axis 215 is substantially perpendicular to the second longitudinal axis 234. A preferred rotation of the lifter S/A 230 is depicted by the reference R.

FIG. 16 depicts a preferred lift position, in which a first lifter pin 246 is fully extended and able to contact a first driver protrusion 228. The shield 210 would not be necessary in order for the lifter S/A 230 to perform the lift stroke.

Referring now to FIG. 17, a “pin profile” view of the plurality of lifter pins 232 of FIG. 16 is illustrated. The first lifter pin 246 is fully extended and able to contact the first driver protrusion 228. Note that a partially extended lifter pin 248 indicates its position on the ramp 254, which is preventing that lifter pin from fully extending.

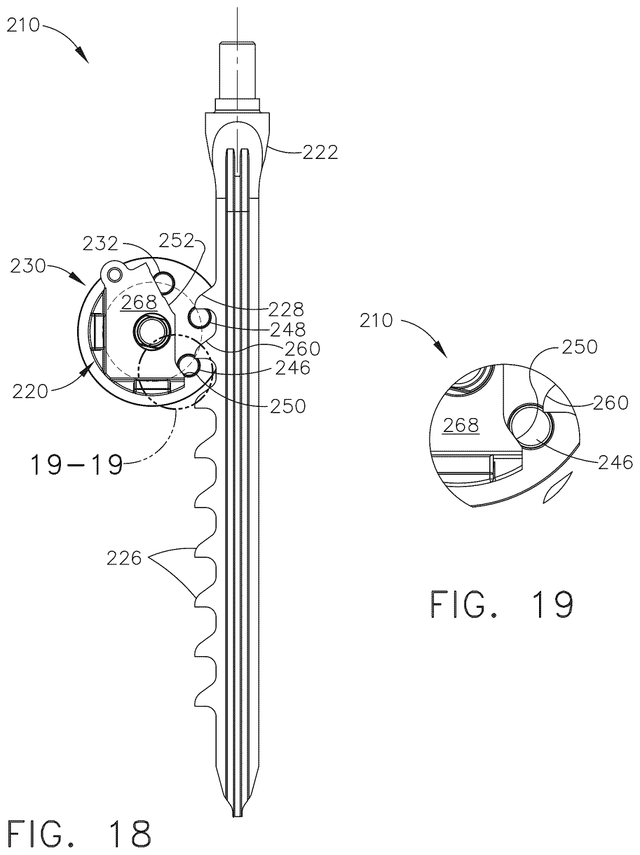

Referring now to FIG. 18, an interference condition is depicted in which the first lifter pin 246 would potentially clash with a second driver protrusion 260 if the shield 210 was not used. However, the shield 210 is included in FIG. 18, and the ramp 254 is partially compressing the first lifter pin 246 so that instead of clashing, that pin will slide under the second driver protrusion 260 and then fully extend ready to contact the first driver protrusion 228. The partially extended lifter pin 248 is shown this time ready to slide under the first driver protrusion 228.

Referring now to FIG. 19, an enlarged view of the interference condition is depicted. The first lifter pin 246 has not yet cleared the exit edge 250 of the ramp 254, and thus remains partially compressed. This partial compression allows the first lifter pin 246 to slide under the second driver protrusion 260, thereby avoiding a clashing of parts.

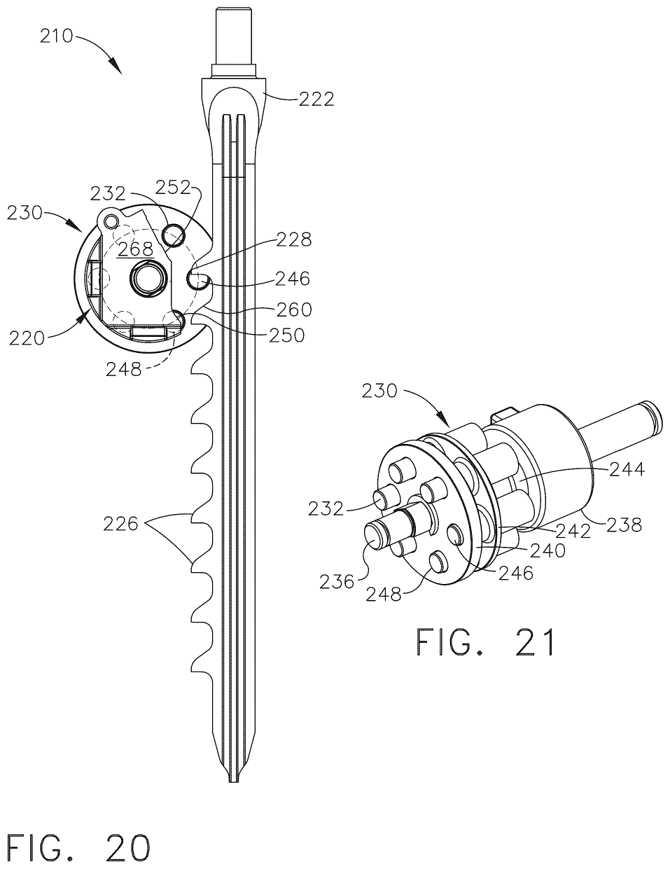

Referring now to FIG. 20, a blocked condition is depicted. If the shield 210 was not present, the lifter pin 248 would clash with the second driver protrusion 260. Note that even without the shield 210, the first lifter pin 246 would still be partially compressed behind the first driver protrusion 246. However, since the shield 210 is depicted, the lifter pin 248 is partially compressed while in contact with the ramp 254. When the lifter S/A 230 begins to rotate, the lifter pin 248 will slide behind the second driver protrusion 260, and then fully extend once past. Then, that lifter pin 248 will correctly contact the first driver protrusion 228 and the lift stroke will begin.

Referring now to FIG. 21, a “pin profile” of the plurality of lifter pins 232 of FIG. 20 is illustrated. The first lifter pin 246 and the partially compressed lifter pin 248 are shown partially retracted, due to their contact with the first driver protrusion 228 and the ramp 254, respectively. The remaining lifter pins 232 are fully extended.

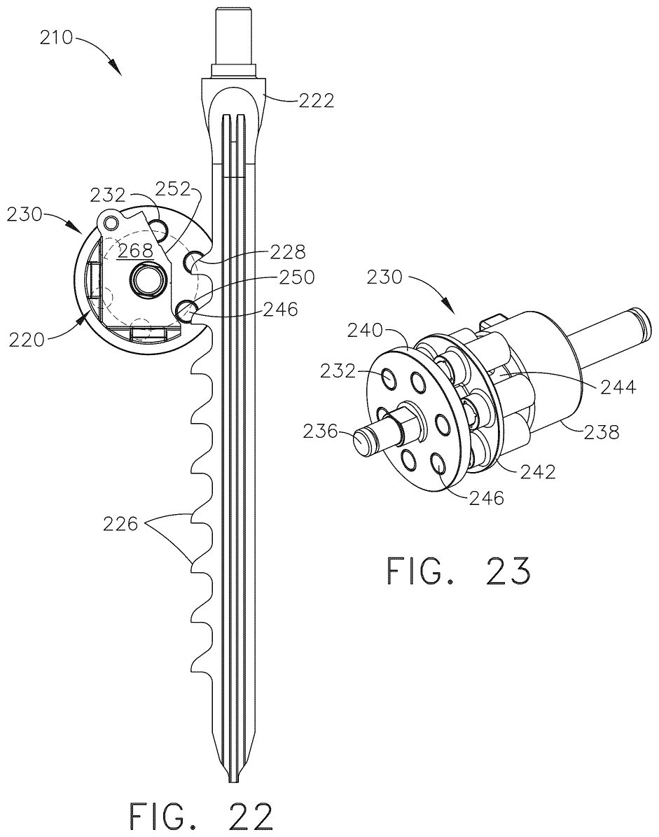

Referring now to FIG. 22, the end of the drive stroke is depicted. All of the lifter pins 232 are fully retracted. Once the lift stroke is initiated, the solenoid 238 will actuate and force the plunger 244 and the holder 242 to move towards the shield 220, thus extending the lifter pins 232 forward.

Referring now to FIG. 23, a “pin profile” of the plurality of lifter pins 232 of FIG. 22 is depicted. All of the lifter pins 232 are fully retracted, and are basically flush with the guide 240.

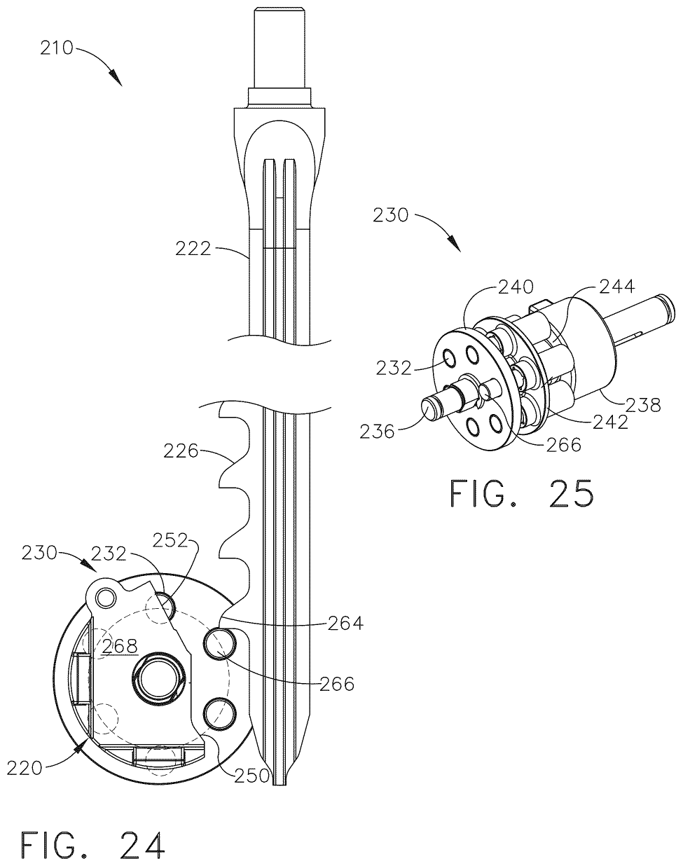

Referring now to FIG. 24, the ready position is depicted. In the ready position, the last lifter pin 266 “holds” the last driver protrusion 264. All of the other lifter pins 232 are fully retracted. The last lifter pin 266 would also retract, but the force of the last driver protrusion 264 on this pin prevents the pin from retracting.

Referring now to FIG. 25, a “pin profile” of the plurality of lifter pins 232 of FIG. 24 is depicted. Only the last lifter pin 266 is shown fully extended, and the remaining lifter pins 232 are fully retracted.

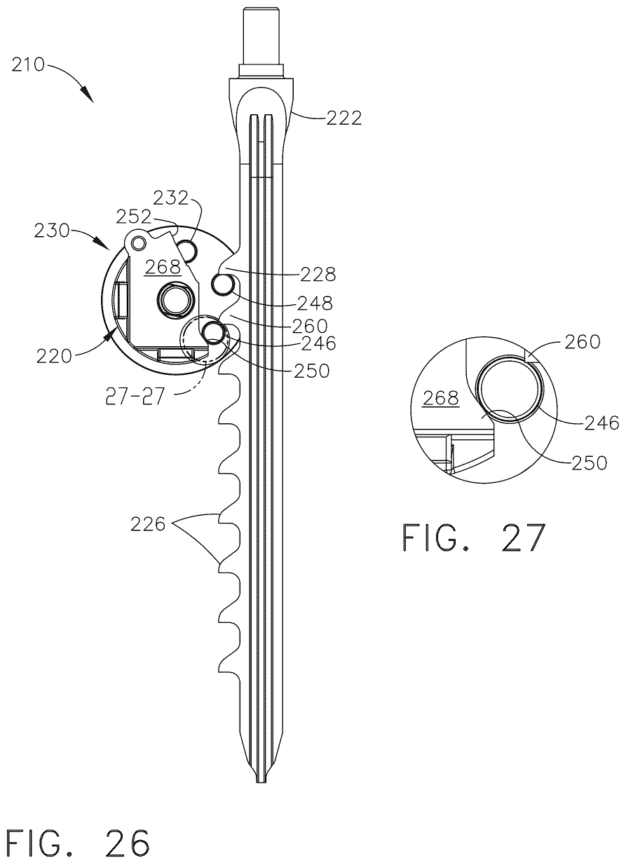

Referring now to FIG. 26, a “maximum offset” of the shield 220 is depicted. The first lifter pin 246 is shown barely contacting the exit edge 250 of the ramp 254, and is also barely going to slide under the second driver protrusion 260 once the lifter S/A 230 begins to rotate. The lifter pin 248 is also barely in contact with the first driver protrusion 228, which means this lifter pin 248 is partially compressed and will slide under the protrusion 228. The condition illustrated in FIGS. 26 and 27 are a prime example of the effectiveness of the shield 220 in preventing an interference condition.

Referring now to FIG. 27, an enlarged view of the near interference condition of FIG. 26 is depicted. The first lifter pin 246 is depicted barely in contact with the exit edge 250 of the ramp 254, and yet will still be able to slide behind the second driver protrusion 260.

### Third Embodiment

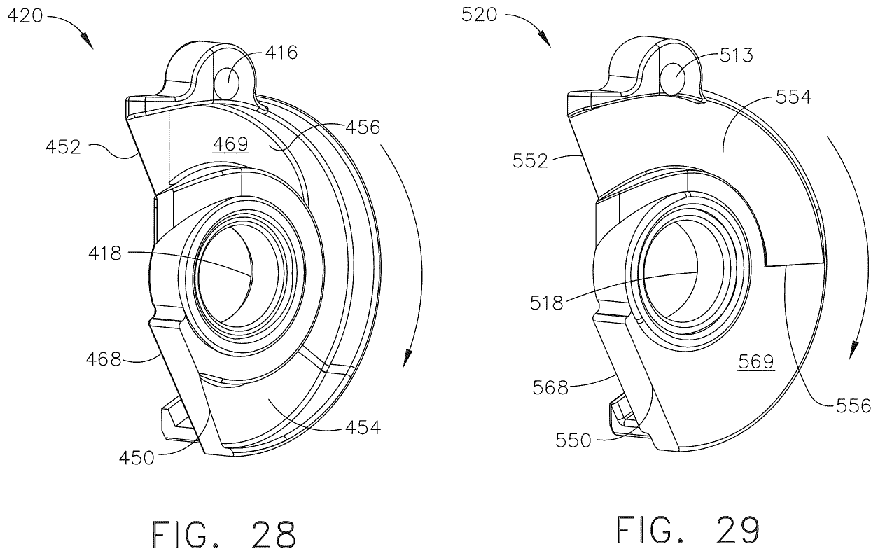

Referring now to FIG. 28, a second alternative embodiment shield is generally depicted by the reference numeral 420. The shield 420 includes a fastener through-hole 416, a central through-hole 418, a first side 468, a second side 469, an entrance edge 452, a guide 456, a ramp 454, and an exit edge 450. In FIG. 28, the ramp 454 only begins proximal to the exit edge 450. In other words, each lifter pin would only begin to compress as it travels proximal to the driver while the lifter S/A rotates for a lift stroke. The lifter pins are partially compressed (and partially extended) as they slide along the ramp 454 and the guide 456, and are compressed to their maximum extent as the pins reach the exit edge 450, after which the lifter pins move from a partially-extended condition to a fully-extended condition.

### Fourth Embodiment

Referring now to FIG. 29, a third alternative embodiment shield is generally depicted by the reference numeral 520. The shield 520 includes a fastener through-hole 513, a central through-hole 518, a first side 568, a second side 569, an entrance edge 552, a ramp 554, a guide 556, and an exit edge 550. In this third alternative embodiment, the ramp 554 begins proximal to the entrance edge 552, and tapers “upwards” until it reaches the guide 556, and then remains flat until reaching the exit edge 550. Each lifter pin would begin to compress almost immediately upon contact with the entrance edge 552, while the lifter S/A rotates for a lift stroke.

### Fastener Driving Tool

Referring now to FIG. 30, the fastener driving tool is generally designated by the reference numeral 600. The tool 600 has a magazine 620 that holds a plurality of fasteners, a guide body 624 (also sometimes referred to herein as a “shield”) near the front end, a fastener exit end 622, and a longitudinal axis of the working cylinder 650. An outer front wall 626, a left-side pressure chamber outer wall 636, and a right-side pressure chamber wall 638 (see FIG. 31) are partially wrapped around a motor 630, a motor housing 631, a gearbox housing 632, and a chassis 634.

An upper pressure chamber end (also sometimes referred to herein as an “end cap”) 610 is secured (via a plurality of fasteners 628) to the end of the outer front wall 626, the left-side pressure chamber outer wall 636, and the right-side pressure chamber outer wall 638 (not shown in this view). The end cap 610 and the chassis 630 provide an air-tight seal at the outer walls 626, 636, and 638.

Referring now to FIG. 31, the tool 600 is shown in an exploded view. A piston stop retaining ring 652 is positioned between a lower seal 680 and the piston stop 654. An upper seal 657 seals the junction between the end cap 610 and a cylinder chamber 656. A left-side pressure chamber 642 and a right-side pressure chamber 644 partially surround, and communicate with, the cylinder chamber 656, and together with the end cap 610 comprise a main storage chamber. The main storage chamber is filled with compressed gas, and this compressed gas along with a piston 660, a driver 662, and a lifter subassembly (S/A) 670, comprise a gas spring. The driver 662 exhibits a plurality of protrusions or teeth 663.

The ready position of the tool 600 is when the piston 660 is proximal to the end cap 610. The tool engages in a drive stroke when the piston 660 is released from the lifter S/A 670, at which time the compressed gas pressure will force the piston 660 to move toward the driven position. The pressure of the gas in the main storage chamber (i.e., the end cap 610, the left-side pressure chamber 642, and the right-side pressure chamber 644) is sufficiently high to quickly force the piston 660 and the driver 662 downward so as to properly seat a fastener into a substrate.

A drive stroke typically occurs when a trigger (not shown in this view) is engaged by a human user, and the fastener exit end 622 is pressed against a workpiece. When the trigger is pulled, the lifter S/A 670 rotates, thereby releasing the driver 662 from making contact with the lifter; then the force of the compressed gas in the end cap 610 and the left and right-side pressure chambers 642 and 644 (i.e., the main storage chamber) force the piston 660 and the driver 662 towards the fastener exit end 622. A fastener from the fastener magazine 620 is forced through the guide body 624 and out of the fastener exit end 622 by the driver 662.

As the driver 662 is being moved downward, the piston 660 is forcing air (or possibly some other gas) out of a variable venting volume that is below the piston 660. This volume of air is moved through a vent to atmosphere (not shown), and it is desired that this be a low resistance passageway, so as to not further impede the movement of the piston 660 and driver 662 during their downward stroke. The pressurized gas above the piston 660 is not vented to atmosphere, but instead remains within the combination of the main storage chamber and a variable displacement volume.

One aspect of the present invention is to provide a rather large storage space volume to hold the pressurized gas that is also used to drive the piston 660 downward during a driving stroke of the driver 662. The interior volume of the end cap 610 is a completely open space, which is in communication with the left-side pressure chamber 642 and the right-side pressure chamber 644. It is preferred that the volume of the end cap 610 and the left-side and right-side storage chambers 642 and 644 be larger than the total volume of the cylinder working spaces. This will allow for a powerful and quick stroke.

The illustrated embodiment allows for both a quick firing (or driving) stroke time and also a fairly quick “lifting” time to bring the driver 662 back to its upper position, ready for the next firing (driving) stroke. Both of these pneumatic and mechanical actions can sequentially occur quickly and allow a user to quickly place fasteners into a surface, perhaps as fast as two to three operational cycles per second.

The working pressure in the system could preferably be around 120 PSIG, and should probably be at least 100 PSIG for a quick-firing tool. By the term “working pressure” the inventors are referring to the pressure in the end cap 610 and the left-side and the right-side pressure chambers 642 and 644 at the time the piston 660 is at its ready position, which is when it is at (or proximal to) its uppermost travel position.

It should be noted that other gases besides air can be used for the main pressure storage chamber and the variable displacement volume, if desired. While dry and clean air will work fine in many or most applications, alternative gases could be used as the “charge gas,” such as nitrogen gas. In fact, bottled nitrogen gas is preferred.

### Holder Subassembly

Referring now to FIG. 32, a holder subassembly (S/A) 700 is depicted in an exploded view. Each individual lifter pin 732 exhibits a small flange 748 on one end, and includes upper lifter pin springs 744 that seat on each lifter pin, and lower lifter spring pins 746 that each seat inside a plurality of lifter pin housings 736, and a housing cap 740 for each lifter pin that “closes” the base of the lifter pin housings. The flanges 748 separate each lifter pin spring “set.” A holder 742 includes the plurality of lifter pin housings 736, and is preferably constructed as a unitary structure. While this is not a requirement, the holder 742 can be molded as a completed part, and thus does not have to be partially assembled with other internal parts, and then finally assembled later. The holder 742 exhibits a central opening 730, and the plurality of lifter pin housings 736 each exhibit an opening 729. Each opening 729 holds a single lower lifter spring 746, a single lifter pin 732, a single upper lifter pin spring 744, and a single housing cap 740.

In the illustrated embodiment, the six openings 729 (also sometimes referred to herein as a “second plurality of openings”) hold the six lifter pins 732 in a slidable manner. In other words, the lifter pins 732 may linearly displace while being “held” by the holder's openings 729. The upper lifter pin springs 744 and the lower lifter spring pins 746 allow for the lifter pins 732 to linearly slide during an interference condition, or when in contact with the ramp on the shield.

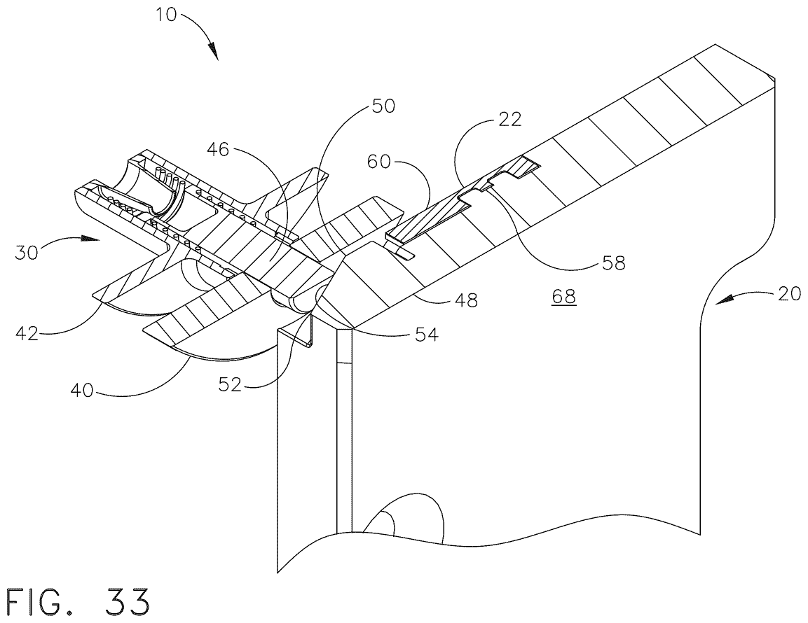

Referring now to FIG. 33 (i.e., the first embodiment), the first lifter pin 46 is shown in direct contact with the ramp 54. As the lifter S/A 30 rotates to initiate a lift stroke, the first lifter pin 46 will slide towards the right (in this view), slide past the exit edge 50, and then contact and slide behind the second driver protrusion 60. Without the presence of the ramp 54, if the driver 22 is misaligned, the first lifter pin 46 would simply crash into the second driver protrusion 60, and thus cause a jam condition.

As the lifter S/A 30 continues to rotate, the first lifter pin 46 will continue sliding past the second driver protrusion 60 and then will fully extend, and then continue sliding until contacting an edge of the first driver protrusion 28. At this point, the lift stroke will ‘begin,’ because once contact is made between the first lifter pin 46 and an edge of the first driver protrusion 28, the rotation of the lifter S/A 30 will force the driver 22 ‘upwards’ towards the ready position.

Note that some of the embodiments illustrated herein do not have all of their components included on some of the figures herein, for purposes of clarity. To see examples of such outer housings and other components, especially for earlier designs, the reader is directed to other U.S. patents and applications owned by Kyocera Senco. Similarly, information about “how” the electronic controller operates to control the functions of the tool is found in other U.S. patents and applications owned by Kyocera Senco. Moreover, other aspects of the present tool technology may have been present in earlier fastener driving tools sold by the Assignee, Kyocera Senco Industrial Tools, Inc., including information disclosed in previous U.S. patents and published applications. Examples of such publications are patent numbers U.S. Pat. Nos. 6,431,425; 5,927,585; 5,918,788; 5,732,870; 4,986,164; 4,679,719; 8,011,547, 8,267,296, 8,267,297, 8,011,441, 8,387,718, 8,286,722, 8,230,941, 8,602,282, 9,676,088, 10,478,954, 9,993,913, 10,549,412, 10,898,994, 10,821,585 and 8,763,874; also published U.S. patent application No. 2020/0156228, published U.S. patent application No. 2021/0016424, published U.S. patent application No. 2020/0070330, and published U.S. patent application No. 2020/0122308; also U.S. patent application Ser. No. 18/135,249, filed on Apr. 17, 2023, and U.S. patent application Ser. No. 18/221,507, filed on Jul. 13, 2023. These documents are incorporated by reference herein, in their entirety.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two (male and female) structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two (male and female) structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

What is claimed is:

1. A lifter for use in a fastener driving machine, the lifter comprising:
a rotatable lifter shaft including a first end and a second end, and a longitudinal axis that extends at least between the first end and the second end;
an actuator that is positioned between the first and second ends;
a rotatable lifter subassembly, including:
a holder that is positioned proximal to the actuator, and is movable by action of the actuator, the holder exhibiting a second plurality of openings;
a guide that is positioned proximal to the holder, the guide exhibiting a first plurality of openings;
a return spring that provides a force against the holder in a direction that is substantially parallel to the longitudinal axis of the lifter shaft; and
a plurality of lifter pins that are seated in the second plurality of openings and that are movable in a direction substantially parallel to the longitudinal axis; and
a shield that is positioned proximal to the second end and that covers at least a portion of the plurality of lifter pins, the shield is operable to force at least one of the plurality of lifter pins to partially retract in a direction towards the actuator during a lifting stroke.

2. The lifter of claim 1, further comprising: a driver having a path of movement that is substantially perpendicular to the lifter longitudinal axis, the driver including a plurality of driver protrusions along at least one longitudinal edge of the driver, the driver being positioned proximal to the rotatable lifter subassembly.

3. The lifter of claim 2, wherein: if there is a potential interference condition between a misaligned driver and at least one of the plurality of lifter pins, then at the beginning phase of the lifting stroke, the shield prevents an actual interference condition by allowing the plurality of lifter pins to continue moving along a surface of the misaligned driver, as the lifter subassembly rotates, until reaching an unblocked position, at which point the at least one of the plurality of lifter pins is operable to extend and to contact an edge of at least one of the plurality of driver protrusions and begins to force the driver into the lifting stroke.

4. The lifter of claim 3, wherein: each one of the plurality of lifter pins:
is mechanically biased, by at least one of the actuator and at least one of a first plurality of lifter pin springs, to attempt to move toward an extended position through one of the first plurality of openings for use in the lifting stroke by the rotatable lifter subassembly; and
is mechanically biased, by at least one of the actuator and at least one of a second plurality of lifter pin springs, to attempt to move in the opposite direction, toward a retracted position, for use in a driving stroke by the rotatable lifter subassembly.

5. The lifter of claim 4, wherein:
the shield exhibits a first side and a second, opposite side; and
the second side exhibits a ramp.

6. The lifter of claim 5, wherein:
the plurality of lifter pins are spaced-apart in a circular pattern around the holder;
as the lifter subassembly rotates, each one of the plurality of lifter pins contacts the ramp;
the ramp forces each one of the plurality of lifter pins to partially retract, and as each one of the plurality of lifter pins rotates past contact with the ramp, each one of the plurality of lifter pins is retracted far enough to continue sliding across a surface of a misaligned driver; and
as the plurality of lifter pins continue to rotate past the misaligned driver, each one of the plurality of lifter pins extends and is operable to contact an edge of one of the plurality of driver protrusions to begin or to continue the lifting stroke.

7. The lifter of claim 1, wherein:
the actuator comprises a solenoid having a movable plunger that forces the holder to move during the lifting stroke.

8. A portable fastener driving tool, comprising:
a pressure chamber containing a pressurized gas;
a working cylinder that includes a movable piston, in which the working cylinder exhibits a first end and a second, opposite end;
a movable driver that is in communication with the movable piston at least during a drive stroke;
a rotatable lifter subassembly that is in communication with the movable driver at least during a return stroke;
a motor that provides power to the lifter subassembly; and
a shield that is in mechanical communication with the lifter subassembly at least during the return stroke, in which the shield is operable to prevent an interference condition between the movable driver and the rotatable lifter subassembly.

9. The tool of claim 8, further comprising:
a rotatable lifter shaft including a first end and a second end, and exhibiting a longitudinal axis that extends at least between the first end and the second end; and
an actuator that is positioned between the first and second ends.

10. The tool of claim 9; wherein: the rotatable lifter subassembly exhibits:
a holder that is positioned proximal to the actuator, the holder exhibiting a second plurality of openings;
a guide that is positioned proximal to the holder, the guide exhibiting a first plurality of openings;
a return spring that provides a force in a direction that is substantially parallel to the longitudinal axis of the lifter shaft; and
a plurality of lifter pins that are seated in the second plurality of openings and that are movable in a direction substantially parallel to the longitudinal axis, in which the plurality of lifter pins partially extends through the first plurality of openings.

11. The tool of claim 10, wherein:
the shield exhibits a first side and a second, opposite side; and
the second side exhibits a ramp.

12. A lifter for use in a fastener driving machine, the lifter comprising:
a rotatable lifter shaft including a first end and a second end;
an actuator that is positioned between the first and second ends;
a rotatable lifter subassembly, including:
a holder that is positioned proximal to the actuator;
at least one guide that is positioned proximal to the holder, the at least one guide exhibiting a first plurality of openings;
a return spring proximal to the holder; and
a plurality of lifter pins that at least partially extend through the first plurality of openings; and
a shield that covers at least a portion of the plurality of lifter pins.

13. The lifter of claim 12, further comprising: a driver having a path of movement that is substantially perpendicular to the lifter longitudinal axis, the driver including a plurality of driver protrusions along at least one longitudinal edge of the driver, the driver being positioned proximal to the rotatable lifter subassembly.

14. The lifter of claim 13, wherein:
the shield exhibits a first side and a second, opposite side; and
the second side exhibits a ramp.

15. The lifter of claim 14, wherein:
as the lifter subassembly rotates, each one of the plurality of lifter pins contacts the ramp;
the ramp forces each one of the plurality of lifter pins to partially retract, and as each one of the plurality of lifter pins rotates past contact with the ramp, each one of the plurality of lifter pins is retracted far enough to continue sliding across a surface of a misaligned driver; and
as the plurality of lifter pins continue to rotate past the misaligned driver, each one of the plurality of lifter pins extends and is operable to contact an edge of one of the plurality of driver protrusions to begin or to continue a lifting stroke.

16. The lifter of claim 15, wherein: each one of the plurality of lifter pins:
is mechanically biased, by at least one of the actuator and at least one of a first plurality of lifter pin springs, to attempt to move toward an extended position for use in the 127 lifting stroke by the rotatable lifter subassembly; and
is mechanically biased, by at least one of the actuator and at least one of a second plurality of lifter pin springs, to attempt to move in the opposite direction, toward a retracted position, for use in a driving stroke by the rotatable lifter subassembly.

17. A method for lifting a driver in a fastener driving tool, said method comprising:
(a) providing:
a pressure chamber containing a pressurized gas;
a working cylinder that includes a movable piston, said working cylinder being in fluidic communication with the pressure chamber, in which the working cylinder exhibits a first end and a second, opposite end;
a movable driver that is in communication with the movable piston at least during a drive stroke, the movable driver moving through a driver track between at least a “ready” position and a “driven” position;
a lifter subassembly that is in communication with the movable driver at least during a return stroke;
a prime mover that provides power to the lifter subassembly; and
a shield that is in mechanical communication with the lifter subassembly at least during the return stroke;
(b) rotating the lifter subassembly during an initial phase of the return stroke, and using the shield to force the at least one lifter pin to at least partially retract which, if the movable driver is misaligned, prevents the at least one lifter pin from physically contacting an edge of a first protrusion of the movable driver; and
(c) after the initial phase of the return stroke, fully extending the at least one lifter pin of the lifter subassembly so as to make physical contact with an edge of a second protrusion of the movable driver, and further rotating the lifter subassembly so as to lift the movable driver toward a “ready” position.

18. The method of claim 17, further comprising:
after the at least one lifter pin clears the shield, if the movable driver is misaligned, then partially extending the at least one lifter pin so that it slides along a surface of the movable driver; and
after the at least one lifter pin clears the movable driver, fully extending the at least one lifter pin.

19. The method of claim 17, further comprising:
during the drive stroke, retracting the at least one lifter pin so as prevent contact with the movable driver.

20. The method of claim 17, further comprising:
the lifter subassembly includes a holder with at least one opening that contains at least one lifter pin spring and further contains the at least one lifter pin; and
using at least one of the actuator and the at least one lifter pin spring, forcing the at least one lifter pin to extend during the return stroke.

21. The method of claim 17, further comprising:
after the at least one lifter pin clears the shield, if the movable driver is not misaligned, then fully extending the at least one lifter pin so as to make physical contact with an edge of the first protrusion of the movable driver, and further rotating the lifter subassembly so as to lift the movable driver toward a “ready” position.
